(19) United States
(12) Patent Application Publication
(10) Pub. No.: US 2013/0095018 A1
(43) Pub. Date: Apr. 18, 2013

(54) UP-FLOW FLUIDIZED BED DRY SCRUBBER AND METHOD OF OPERATING SAME

(71) Applicant: Herman W. Pilats, Pittsburgh, PA (US)

(72) Inventor: Herman W. Pilats, Pittsburgh, PA (US)

(21) Appl. No.: 13/275,380

(22) Filed: Oct. 18, 2011

(51) Int. Cl. B01D 53/75

(52) U.S. Cl. 423/240 S; 423/243.01; 422/140

(57) ABSTRACT

An up-flow fluidized bed dry scrubber and a method of operating same. The scrubber includes up-flow reactors. The reactors receive an exhaust gas flow containing pollutants and each reactor includes one or more spray lances that inject a dry, powdered sorbent into the flow vertically onto material dispersion assemblies installed in the reactor and one or more dual-fluid spray lances with multiple spray nozzles that introduce humidification water into the flow in the reactor. The sorbent and the humidification water combine to create a fluidized sorbent bed in the flow when the flow is sufficient to suspend the fluidized sorbent bed in the reactor, in which pollutants react with the sorbent in the bed and are removed from the gas as the gas flows through the bed in the reactor.

### TECHNICAL FIELD

The technical field is systems for removing pollutants, particularly acid gas constituents, contained in process off-gas exhaust streams.

### BACKGROUND

Current systems for removing pollutants, particularly acid gas constituents, contained in process off-gas exhaust streams are inefficient and require substantial equipment. Such systems typically introduce a sorbent to the exhaust stream. The acid gas constituents in the exhaust stream react with the sorbent. The reacting acid gas becomes attached or absorbed by the sorbent on the sorbent particle surface. The sorbent is removed from the exhaust stream, effectively removing the acid gas constituents.

Generally, only a portion of the sorbent initially introduced into the exhaust gas stream is consumed by each reaction. Accordingly, in many systems, a portion of the used sorbent is recycled and reintroduced into exhaust stream for further reaction and removal of pollutants. Typically, the used sorbent is removed from the exhaust stream by a particulate dust collector (e.g., baghouse) installed downstream of the sorbent injection point. The dust collector is supplied with collection hoppers and material removal devices, such as air slide conveyors, to convey the materials to a holding bin or silo for disposal. These air slide conveyors may also be provided with a material diversion system that allows a portion of the used sorbent to be collected and mixed with new sorbent for reintroduction into the exhaust gas stream.

Systems, such as the system described here, typically achieve about twenty to thirty percent (20-40%) efficiency, measured as a percentage of the acid gas constituents removed, without sorbent recycling. The baghouse unit, which is usually thirty to forty feet tall and its air slide conveyors, must be elevated on high structural steel supports for the proper transporting and discharging of the used sorbent for recycling, which requires a substantial amount of capital and space be devoted to implement this design arrangement. Improvements in the efficiency of and capital and space investments for such systems are needed.

### SUMMARY

Embodiments described herein have numerous advantages, including overcoming the defects of the prior art described above. These advantages may be achieved by a up-flow fluidized bed dry scrubber. The up-flow fluidized bed dry scrubber includes a plurality of up-flow reactors, the flow reactors receiving an exhaust gas flow containing pollutants and each flow reactor including one or more spray lances that inject a dry, powdered sorbent into the exhaust gas flow vertically onto material dispersion assemblies installed in the flow reactor and one or more dual-fluid spray lances with multiple spray nozzles that introduce humidification water into the exhaust gas flow in the up-flow reactor. The sorbent and the humidification water combine to create a fluidized sorbent bed in the exhaust gas flow when the exhaust gas flow is sufficient to suspend the fluidized sorbent bed in the flow reactor in the up-flow reactor, whereby pollutants react with the sorbent in the fluidized sorbent bed and are removed from the exhaust gas as the exhaust gas flows through the fluidized sorbent bed in the up-flow reactor.

Advantages may also be achieved by a method of operating an up-flow fluidized bed dry scrubber. The method introduces and maintains an exhaust gas flow with sufficient force to maintain a fluidized bed of suspended sorbent in an up-flow reactor, injects a sorbent into the exhaust gas flow in the up-flow reactor, and injects humidification fluid into the injected sorbent, so that a suspended, fluidized sorbent bed is created in the exhaust gas flow in the up-flow reactor in which pollutants react with the sorbent and are removed from the exhaust gas.

### BRIEF DESCRIPTION OF THE DRAWINGS

The detailed description may refer to the following drawings, wherein like numerals refer to like elements, and wherein:

FIG. 1A is a diagram of an embodiment showing are top, partial cross-sectional view of an exhaust or off-gas treatment system containing an embodiment of up-flow fluidized bed dry scrubber.

FIG. 1B is a diagram of an embodiment showing are cross-section side view of an exhaust or off-gas treatment system containing an embodiment of up-flow fluidized bed dry scrubber.

FIG. 2 is a diagram showing a cross-sectional side view of an embodiment of up-flow reactor in an upflow fluidized bed dry scrubber.

FIGS. 3A-3B is a diagram showing a cross-sectional side view and top view, respectively, of a portion of an embodiment of up-flow reactor in an upflow fluidized bed dry scrubber.

FIGS. 4A-4C are diagrams illustrating embodiments of sorbent injection lances, deflectors, and humidification injection lances, respectively, used in an embodiment of up-flow reactor in an upflow fluidized bed dry scrubber.

FIG. 5 is a flowchart of a method of operating an up-flow fluidized bed dry scrubber.

### DETAILED DESCRIPTION

Described herein are embodiments of an up-flow fluidized bed dry scrubber. Embodiments of the up-flow fluidized bed dry scrubber overcome the problems described above. For example, embodiments of the up-flow fluidized bed dry scrubber provide a more efficient system for removing pollutants, particularly acid gas constituents, from exhaust gas. Embodiments described herein have achieved in excess of eighty percent (80%) efficiency, measured in the removal of pollutants. Likewise, embodiments described herein provide substantial savings in capital and space over existing systems, requiring substantially less capital and space.

Embodiments provide a new air pollution control device used to remove pollutants, particularly acid gas constituents such as hydrochloric acid (HCl), sulfur oxides (SOₓ), sulfurous acid (H₂SO₃), sulfuric acid (H₂SO₄), hydrofluoric acid (HF) and other acids that may be present in the exhaust gas streams from coal fired boilers, waste incinerators, biomass boilers, furnaces and other such equipment. Indeed, the pollution control device may be used to remove acid gas constituents from practically any system in which a combustion or other process off-gas contains such compounds. Embodiments reduce the quantity of acid gas constituents by introducing a finely divided powdered sorbent, such as hydrated lime (Ca(OH)₂), sodium bicarbonate (NaHCO₃), sodium sesquicarbonate (Na₂CO₃.NaHCO₃.2H₂O) or others into a vertical off-gas, up-flow configured vessel. The dry, powdered sorbent is introduced into through spray lances. Embodiments create a fluidized bed of the sorbent within the vessel using, e.g., two-fluid humidifier nozzles or spray lances in each vertical vessel. The spray lances may each contain multiple, replaceable spray nozzles. This fluidized sorbent bed reacts more efficiently with the acid gas constituents in the exhaust gas. To enhance the neutralization and removal of the acid gas constituents, finely atomized water and/or water containing additional neutralization enhancing agents may be introduced into the gas stream. Water containing additional acid-removal enhancement agents may also introduced in the fluidized sorbent bed (the “reaction zone”) using spray lances. Such enhancement further increases the removal efficiency.

Embodiments also incorporate equipment to allow the reintroduction of the spent sorbent agent, which may contain quantities of un-spent sorbent. This feature reduces sorbent usage and further increases overall system efficiency. For example, after reacting with the exhaust gas, the partially-spent sorbent may returned to a day bin or silo using a pneumatic conveying system for storage and recycling. Such a system removes the reacted sorbent from the dust collector for temporary storage and pneumatic reinjection into the reactor vessel.

Embodiments include additional improvements to further increase efficiency and performance. For example, the vertical reactor vessel may include internal inlet flow guide vanes that uniformly distribute the process off-gases into the reaction zone. Likewise, embodiments may also include internal sorbent dispersion deflectors incorporated within the vessel to uniformly distribute the injected sorbent within the reaction zone. These, and other similar features, may be used to improve sorbent-off-gas mixing, thereby increasing acid gas compound neutralization and removal.

In embodiments, the location of the spray lances and the droplet size of the humidified sorbent are designed and chosen so that the introduced humidification liquid is completely evaporated. In this manner, all reaction compounds (the spent sorbent, the reacted acid gas constituents) are nearly totally dry when they exit from the reactor's gas outlet. The dry reaction compounds may be filtered and removed from the gas stream using a conventional dust collector unit, such as a fabric filter unit (baghouse). The baghouse may be installed downstream from the reactor vessel. The removed partially spent sorbent may be conveyed, for recycling purposes, as described above.

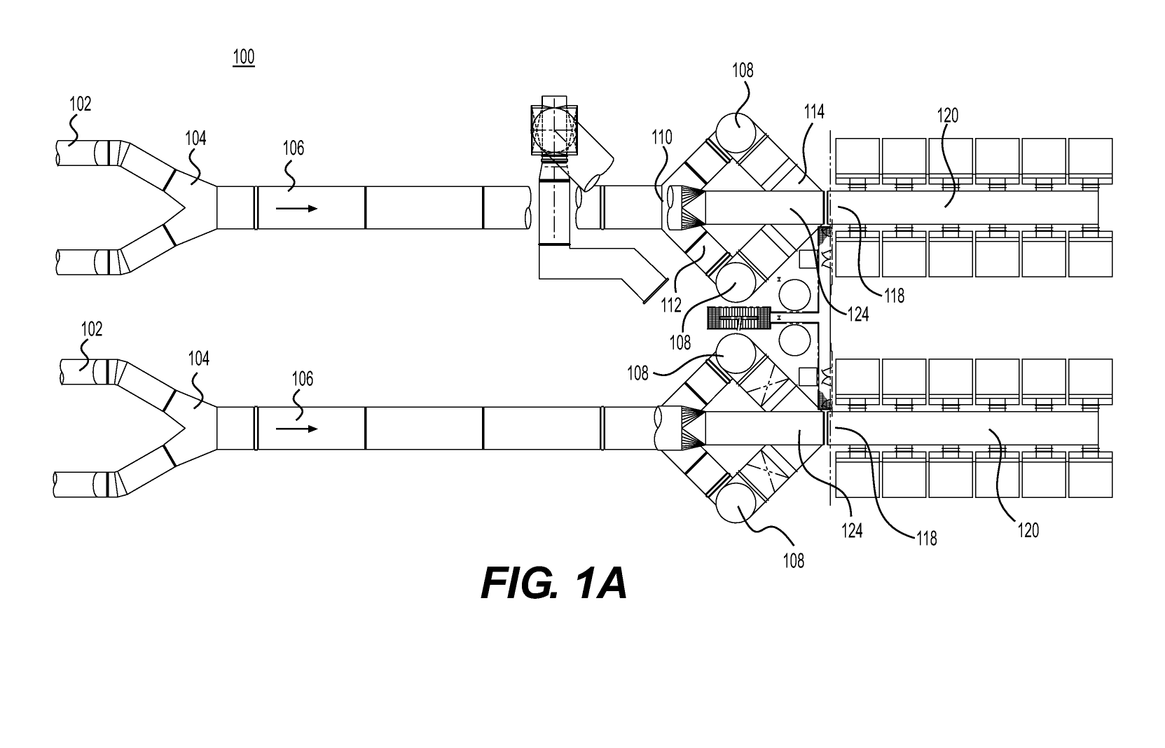

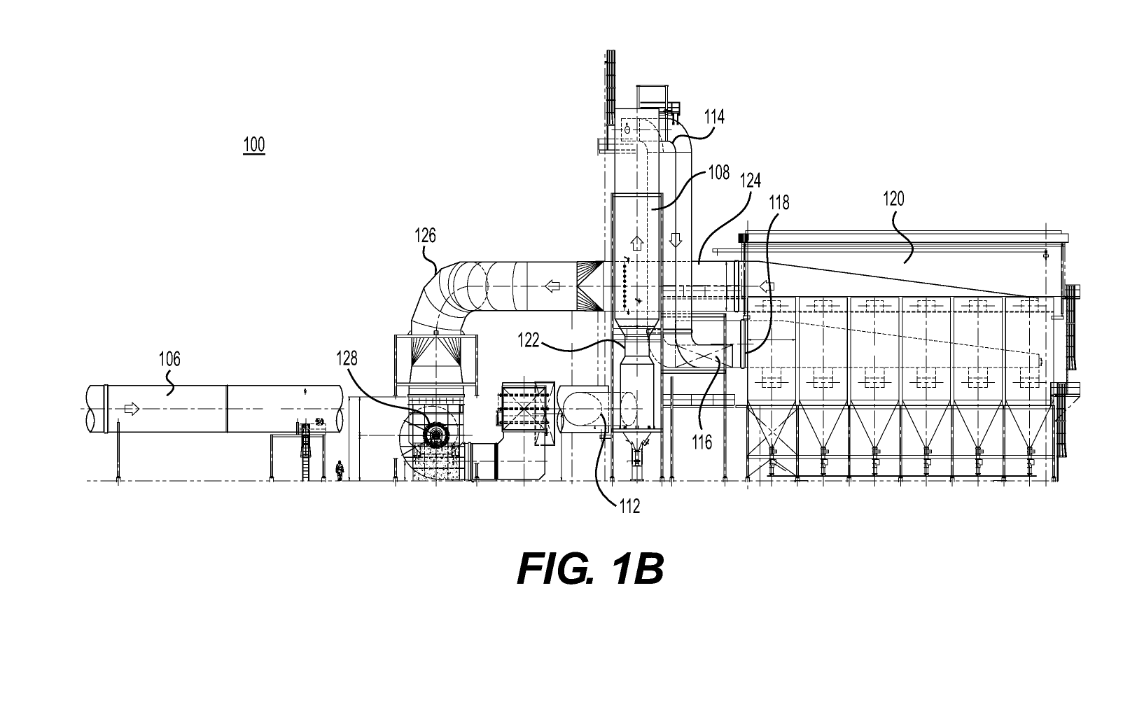

With reference now to FIGS. 1A and 1B, shown is an exhaust or off-gas treatment system 100 containing an embodiment of up-flow fluidized bed dry scrubber 10. With reference first to FIG. 1A, shown is top view of an exhaust or off-gas treatment system 100. Treatment system 100 includes multiple duct-lines 102 downstream from process exhaust fans or other off-gas sources (not shown). Embodiments may treat exhaust or off-gas (referred to hereinafter as exhaust gas for ease of reference) from a single duct or multiple duct lines. In the treatment system 100 shown, two sets of duct-lines 102 are joined through y-branches 104 into two main ducts 106. In other words, treatment system 100 includes two side-by-side treatment lines; embodiments of treatment system 100 may include a single treatment line with one main duct 106 or additional treatment lines with additional main ducts 106. Joining the two process exhaust duct lines 102 of each set into main ducts 106 via y-branches 104 has the effect of combining the dual exhausts into a single process exhaust.

The main ducts 106 feed the exhaust gas flow to embodiments of up-flow fluidized bed dry scrubber 10. The embodiments of up-flow fluidized bed dry scrubber 10 include flow reactors 108. The flow reactors 108 are devices that provide the acid gas emission control and include dual-fluid humidification nozzles or spray lances, dual sorbent feed lances for introducing the fresh and recycled sorbents, and in which the fluidized sorbent bed is created. As shown, each main duct 106 may be split by y-branch 110 into narrower secondary ducts 112 that feed into two separate flow reactors 108. The y-branch 110 causes a uniform distribution of the exhaust gas flow into both reactors.

With continued reference to FIG. 1A, reacted gas, i.e., exhaust gas that has passed through the fluidized bed reactors 108, exits the reactors through outlet ducts 114 that are joined, by y-branch 116, into a single duct 118 leading to the baghouse filter. As described above, embodiments of up-flow fluidized bed dry scrubber 10 include a filtering system to remove reacted sorbent. Such a filtering system may include a baghouse filter 120. Reacted gas flows from exhaust duct 118 into baghouse filter 120. A baghouse filter 120 is a dry filtering system that removes particles from a gas flow. As described herein, baghouse filter 120 removes the reacted sorbent from the gas flow. The removed sorbent may be recycled for further use in the flow reactors 108. The filtered gas flow exits baghouse filter 120 and may be exhausted from treatment system 100 via an exhaust stack (not shown).

With reference to FIG. 1B, shown is a cross-sectional side view of treatment system 100. Shown is main duct 106 of exhaust gas line, a secondary duct 112 feeding exhaust gas flow from main duct 106 to flow reactor 108 of up-flow fluidized bed dry scrubber 10 embodiment. Additional details of flow reactor 108 may be seen from FIG. 1B, including venturi segment or throat 122 which causes further convergence of exhaust gas flow and, therefore, further acceleration of exhaust gas flow through upflow reactor 108. Also seen is secondary duct 114 joined via y-branch 116 into the larger exhaust duct 118. Exhaust duct 118 brings reacted gas flow into baghouse filter 120 of up-flow fluidized bed dry scrubber 10 embodiment. Baghouse filter 120 includes multiple hoppers 124 for collecting used sorbent that is filtered from exhaust gas by baghouse filter 120. Sorbent may fall into the collection hoppers 124 by force of gravity and be removed by the pneumatic conveying system previously mentioned to a day-bin or silo for possible re-introduction into up-flow fluidized bed dry scrubber 10. As shown, in the embodiment shown of treatment system 100, reacted gas flow enters near bottom of baghouse filter 120 and flows upward and back through an exhaust manifold duct 124 towards exhaust fans 126.

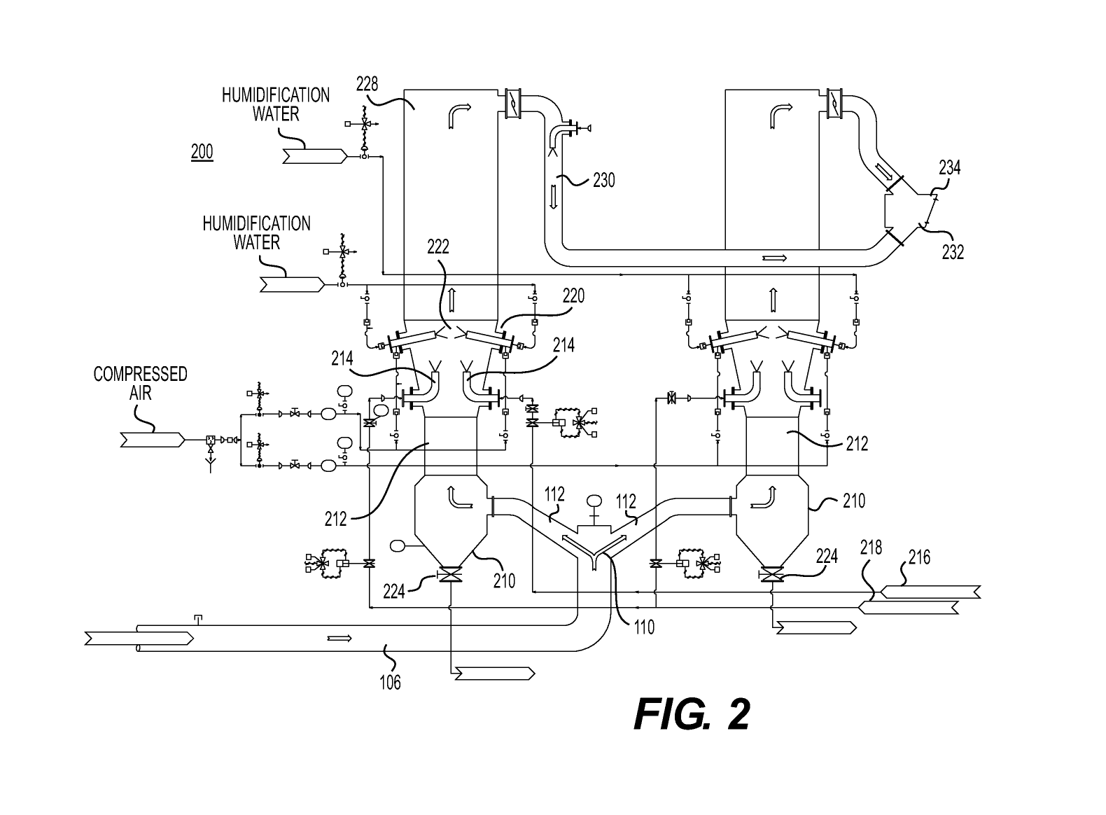

With reference now to FIG. 2, shown is partial cross-sectional view of an embodiment of up-flow fluidized bed dry scrubber 200, including a pair of flow reactors 202. In embodiments, up-flow fluidized bed dry scrubber 200 includes paired flow reactors 202. As discussed below, if the exhaust gas flow is not sufficiently high to operate both flow reactors, up-flow fluidized bed dry scrubber 200 embodiments may automatically shut down one of the paired reactors 202. As shown in FIGS. 1A-1B, exhaust gas enters up-flow fluidized bed dry scrubber 200 through main duct 204. Main duct 204 is split by y-branch 206 into narrower secondary ducts 208. Secondary ducts 208 feed exhaust gas into lower hoppers 210 of flow reactors 202. Exhaust gas passes through venturi throat or segment 212, accelerating the exhaust gas flow to form the fluidized bed of sorbent material. A pair of injection lances 214 may receive an input of fresh sorbent 216 and recycled sorbent 218, respectively, from the fresh sorbent storage silo and from the recycle day-bin or silo pneumatic conveying systems. (not shown). Alternatively, the sorbent injection lances 214 may be provided input of both virgin sorbent 216 and recycled sorbent 218, either mixed or separately. The injection lances 214 spray the dry, powdered sorbent up-wards into the gas flow as shown. Inclined dual-fluid spray lances 220 introduce humidification water into the gas flow. The humidification water mixes with the sprayed, dry, powdered sorbent to create fluidized sorbent beds 222 in the flow reactors 202 to enhance acid gas removal efficiency. The venturi converging segment 224 provides a sufficient gas velocity so that the exhaust gas flow suspends the fluidized sorbent bed 222 in the diverging section of the reactor. In embodiments, the fluidized sorbent bed 222 includes around 500 to 1000 Kg of sorbent material held in suspension, so the exhaust gas flow rate and velocity must be high enough to suspend and maintain the active sorbent material bed and also to convey the sorbent to the baghouse filter installed downstream.

By suspending the fluidized sorbent bed 222 in the exhaust gas flow, embodiments of the up-flow fluidized bed dry scrubber 200 cause the acid gas pollutants to mix intimately with the sorbent and humidification water. This increases the reaction efficiency of the up-flow fluidized bed dry scrubber 200.

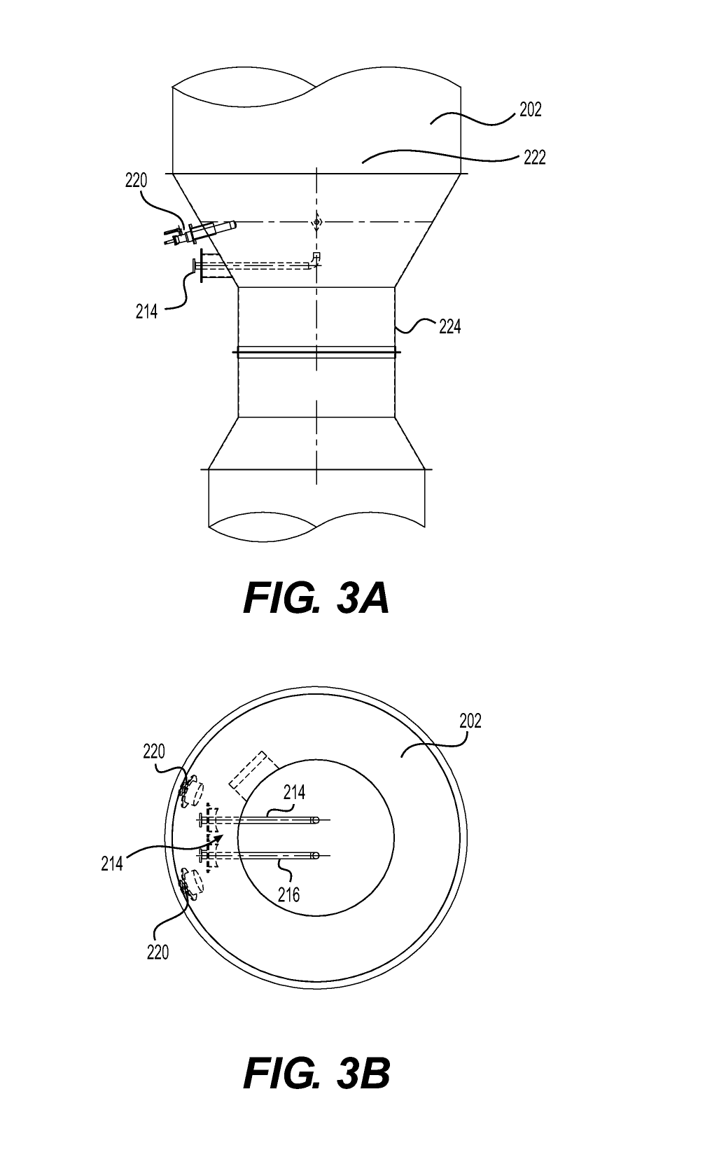

With reference now to FIGS. 3A-3B, shown is a portion of up-flow reactor 202. This portion includes venturi converging segment 224, sorbent injection lances 214, dual-fluid humidification spray lances 220 and fluidized bed zone 222. It is seen here that the humidification lances or spray nozzles 220 may be operated in a redundant fashion. In other words, each flow reactor 202 may include two humidification lances but only need to operate a single humidification lance 220 at a time in order to sufficiently humidify the gas stream and create the fluidized bed zone 222. The dual lance design provides operational redundancy so that if one spray lance 220 becomes clogged, the other one may be enabled for use, while the clogged one is removed from service for maintenance. Also shown here, the up-flow reactor 202 is designed with two sorbent spray lances 214, with one lance used to introduce fresh sorbent 216 and the second one used to introduce recycled sorbent 218. This design allows the system controls to independently vary the injected quantities of both fresh and recycled sorbents and optimize sorbent usage. The sorbent lances discharge sorbent materials into the fluidized bed zone 222 using internally mounted deflectors that disperse the materials uniformly in the fluidized bed zone.

Furthermore, embodiments of up-flow fluidized bed dry scrubber 200 may contain sensors that monitor the exhaust gas flow. The sensors may be connected to a computerized control system (not shown) that includes flow curves indicating the required flow rate curves necessary to maintain and suspend fluidized sorbent bed 222 for given pollutants (e.g., acid gasses) and given sorbents. If the sensors detect that the exhaust gas flow rates are insufficient to maintain and suspend the fluidized sorbent bed 222, a computerized control system may shut down one of the paired flow reactors 202 (alternatively, flow reactors 202 may be manually shut-down). This will cause the operating flow reactor 202 to receive all of the exhaust gas flow from the main duct 204; which will have a greater velocity and strength than if split into both flow reactors 202. If the exhaust flow is still not strong enough, the sorbent feed and humidification water is automatically stopped to both flow reactors 202.

With reference again to FIG. 2, the reactor hoppers 210 include outlet 224 feeding to residue discharge 226. When a flow reactor 202 is shut down, fluidized sorbent bed 222 material will precipitate into the reactor hopper 210. This material may be removed via outlet 224. After passing through fluidized sorbent bed 222, treated exhaust gas exits through flow reactor top 228 and flows through secondary ducts 230 that are joined, by y-branch 232 into exhaust duct 234 preceding the baghouse filter. This treated exhaust gas contains dry, reacted sorbent (i.e., sorbent that has reacted with pollutants (acid gases) contained in the exhaust gas). Exhaust duct 234 conveys exhaust gas containing dry reacted sorbent to a fabric filter or other filter system (e.g., baghouse filter 120 shown in FIGS. 1A-1B). The dry, reacted sorbent is removed and pneumatically conveyed to a silo for disposal and/or to a day bin or storage silo for use as recycled sorbent, as described above.

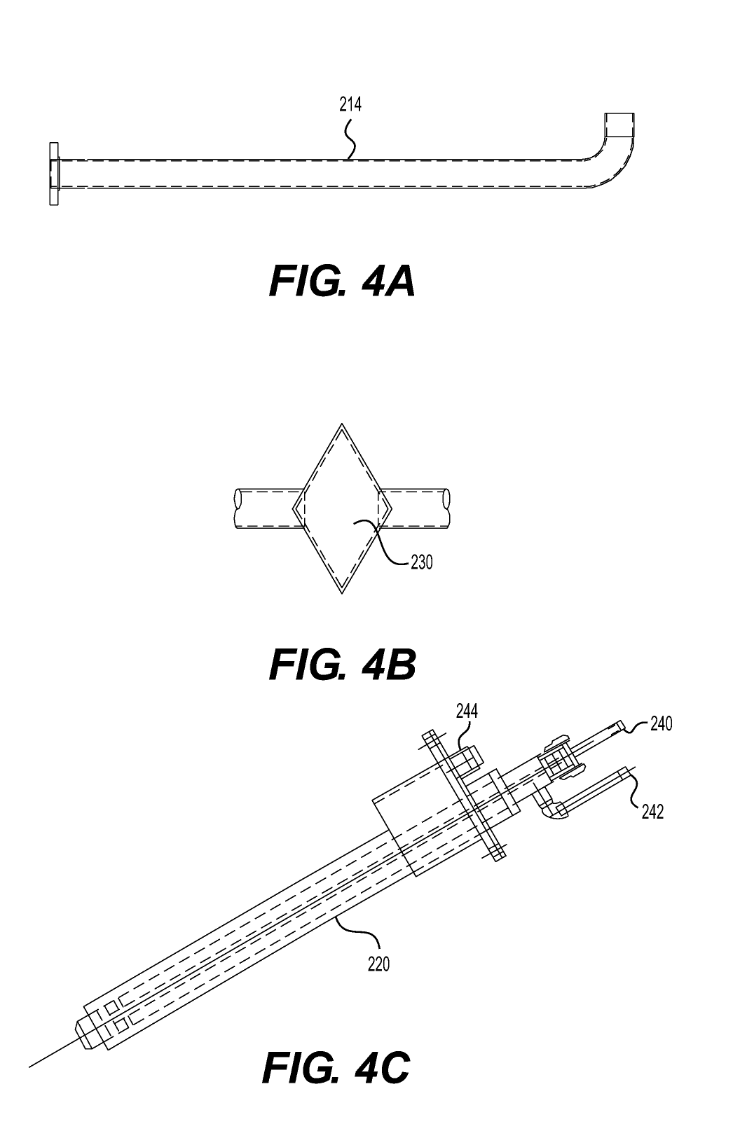

With reference now to FIGS. 4A-4C, shown are embodiments of sorbent injection lances 214, internally mounted deflector 230 and dual-fluid humidification spray lance 220. As shown, sorbent lances 214 may be configured with an up-turned injection nozzle (at end of lance 214). With reference back to FIG. 3A, the sorbent injection lances 214 extend horizontally, perpendicular to the exhaust gas flow in up-flow reactor 202. Sorbent is sprayed from injection lance 214 upwards, in same direction as gas flow, through up-turned injection nozzle. Internally mounted deflectors 230 may be three-dimensionally, diamond-shaped, as shown. The sorbent injected from up-turned injection nozzle of sorbent lances 214 hits deflectors 230 and is dispersed in fluidized sorbent bed 222 zone, in which it is humidified by humidification spray from spray lance 220. As shown, humidification spray lances 220 include a water (or other fluid) connection 240 through which humidification water (or other fluid) is provided, an air connection 242 through which pressurized air is provided, and an air intake 244 through which atmospheric air may be introduced.

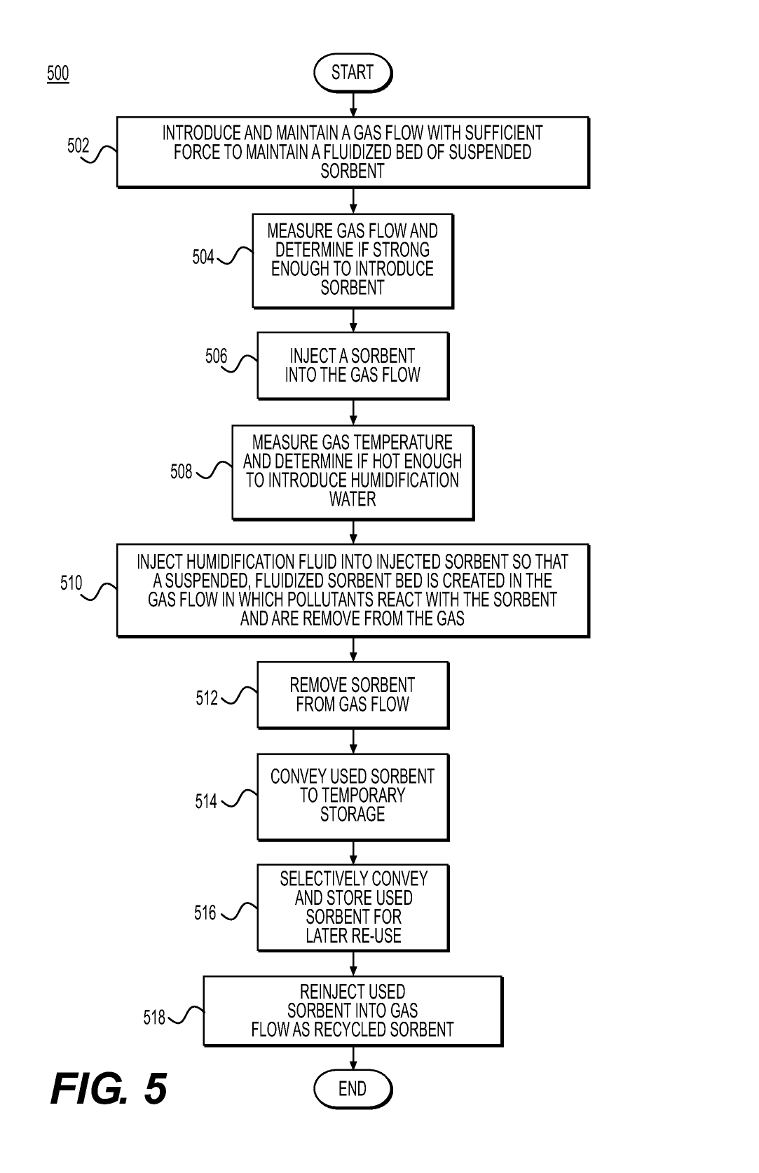

With reference to FIG. 5, shown is a flowchart illustrating an embodiment of a method 500 of operating an up-flow fluidized bed dry scrubber. Method 500 includes. introducing and maintaining an exhaust gas flow with sufficient force to maintain a fluidized bed of suspended sorbent in an up-flow reactor, block 502. Method 500 injects a sorbent, as described herein, into the exhaust gas flow in the up-flow reactor, block 504, and injecting humidification fluid into the injected sorbent, block 506, so that a suspended, fluidized sorbent bed is created in the exhaust gas flow in the up-flow reactor in which pollutants react with the sorbent and are removed. Method 500 may also include removing sorbent from exhaust gas flow, block 508, removing unused, non-reacted sorbent from removed sorbent, block 510, and storing unused, non-reacted sorbent for later use, block 512. Method 500 may also include re-injecting unused, non-reacted sorbent into gas flow as recycled sorbent, block 514. Maintaining the exhaust gas flow 502 may include monitoring the exhaust gas flow and reducing the number of up-flow reactors used in order to maintain the gas flow at sufficient force. Injecting sorbent 504 may include injecting sorbent through injection lance with up-turned injection nozzle onto deflector plate, as described above. Furthermore, injecting sorbent 504 may include injecting fresh, unused sorbent and recycled sorbent, as described herein. Likewise, injecting humidification fluid 506 may include injecting humidification fluid through dual-fluid humidification spray lance that is tilted at an upwards angle in up-flow reactor. Injecting humidification fluid 506 may also include monitoring humidification fluid flow through humidification spray lance and switching to another dual-fluid humidification spray lance if flow is to low (e.g., lance becomes jammed).

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

1. An up-flow fluidized bed dry scrubber comprising:
a plurality of up-flow reactors, the flow reactors receiving an exhaust gas flow containing pollutants and each flow reactor including:
one or more spray lances that inject a dry, powdered sorbent into the exhaust gas flow vertically onto material dispersion assemblies installed in the flow reactor; and
one or more dual-fluid spray lances with multiple spray nozzles that introduce humidification water into the exhaust gas flow in the up-flow reactor, wherein the sorbent and the humidification water combine to create a fluidized sorbent bed in the exhaust gas flow when the exhaust gas flow is sufficient to suspend the fluidized sorbent bed in the flow reactor in the up-flow reactor, whereby pollutants react with the sorbent in the fluidized sorbent bed and are removed from the exhaust gas as the exhaust gas flows through the fluidized sorbent bed in the up-flow reactor.

2. The up-flow fluidized bed dry scrubber of claim 1 further comprising:
one or more main ducts through which the exhaust gas flow passes prior to entering the up-flow reactors; and
a y-branch that splits the one or more main duct into narrower secondary ducts and connects the main duct to the plurality of up-flow reactors.

3. The up-flow fluidized bed dry scrubber of claim 2 wherein the secondary ducts feed exhaust gas into lower hoppers of the flow reactors.

4. The up-flow fluidized bed dry scrubber of claim 1 wherein the up-flow reactors each comprise a venturi throat through which the exhaust gas flow passes, accelerating the exhaust gas flow so that the exhaust gas flow has sufficient velocity to maintain the fluidized sorbent bed.

5. The up-flow fluidized bed dry scrubber of claim 1 wherein the one or more spray lances comprise dual dry sorbent injection lances, wherein a first lance injects fresh sorbent into the up-flow reactor and a second lance injects recycled sorbent.

6. The up-flow fluidized bed dry scrubber of claim 1 wherein each up-flow reactor further includes one or more internally installed dispersion plates and the one or more spray lances inject the dry, powdered sorbent onto the dispersion plates to uniformly distribute injected materials.

7. The up-flow fluidized bed dry scrubber of claim 1 wherein the dual-fluid spray lances are inclined and include replaceable nozzles.

8. The up-flow fluidized bed dry scrubber of claim 1 wherein the each spray lance includes a corresponding spray lance so that if one spray lance becomes clogged or otherwise non-operational, the corresponding spray lance is turned on and injects the dry, powdered sorbent into the exhaust gas flow.

9. The up-flow fluidized bed dry scrubber of claim 1 the each dual-fluid spray lances with multiple spray nozzles may provide sufficient humidification water through one spray nozzle so that the dual-fluid spray lance may continue to operate even if a spray nozzle becomes clogged or otherwise non-operational.

10. The up-flow fluidized bed dry scrubber of claim 1 further comprising a pneumatic conveying system for storage and recycling, wherein the pneumatic conveying system removes partially-spent sorbent for later use.

11. The up-flow fluidized bed dry scrubber of claim 1 further comprising a baghouse filter that removes the reacted sorbent from the gas flow.

12. The up-flow fluidized bed dry scrubber of claim 1 further comprising a day-bin in which new dry, powdered sorbent is stored.

13. The up-flow fluidized bed dry scrubber of claim 1 further comprising a day-bin to which used, partially spent dry, powdered sorbent is returned and stored in for later use.

14. A method of operating an up-flow fluidized bed dry scrubber, comprising:
introducing and maintaining an exhaust gas flow with sufficient force to maintain a fluidized bed of suspended sorbent in an up-flow reactor;
injecting a sorbent into the exhaust gas flow in the up-flow reactor; and
injecting humidification fluid into the injected sorbent, whereby a suspended, fluidized sorbent bed is created in the exhaust gas flow in the up-flow reactor in which pollutants react with the sorbent and are removed from the exhaust gas.

15. The method of claim 14 further comprising removing sorbent from exhaust gas flow.

16. The method of claim 15 further comprising removing unused, non-reacted sorbent from removed sorbent and storing unused, non-reacted sorbent for later use.

17. The method of claim 14 wherein the injecting sorbent includes injecting fresh, unused sorbent and recycled sorbent previously removed from earlier exhaust gas flows in upflow reactor.
